(19) United States
(12) Patent Application Publication
(10) Pub. No.: US 2011/0010891 A1
(43) Pub. Date: Jan. 20, 2011

(54) GROMMET FOR USE IN WINDOW TREATMENTS

(76) Inventor: John Rowley, Gastonia, NC (US)

Correspondence Address: NEXSEN PRUET, LLC, P.O. BOX 10648, GREENVILLE, SC, 29603, US

(21) Appl. No.: 12/836,647

(22) Filed: Jul. 15, 2010

Related U.S. Application Data
(60) Provisional application No. 61/225,738, filed on Jul. 15, 2009.

(51) Int. Cl. F16L 5/00; B23P 11/00

(52) U.S. Cl. 16/2.1; 29/428

(57) ABSTRACT

An eccentric grommet wherein the width, measured radially, is greater through a portion of its circumference. The grommet comprises a body and a washer. The washer or, alternatively, the body may be eccentric, or both. The wider portion of the grommet may have one or more openings formed therein to facilitate attachment of cords, bead chains, or other flexible connectors. The wider portion may be used to in connection with draperies and other window treatments to facilitate opening and closing of the draperies and to add an ornamental design feature.

### CROSS REFERENCE TO RELATED APPLICATIONS

The present application claims the benefit of priority of U.S. Provisional Application No. 61/225,738, filed on Jul. 15, 2009.

### BACKGROUND OF THE INVENTION

The present invention relates generally to grommet devices, and, in particular, to an apparatus and method for using a grommet with window treatments and accessories.

The decoration of windows in residential and commercial settings is often vital to create an aesthetically pleasing and finished appearance. The options available for hanging draperies and other window accessories are seemingly endless. Many of these options tend to be expensive, difficult to install, and limited in their use. Even following extensive trial and error with different window treatment accessories and options, the final window treatment installation and decor often requires the use of multiple devices that each perform separate, specific functions.

Accordingly, there remains a need for an improved apparatus and method that provides the user with a convenient, flexible means to hang window treatments.

### SUMMARY OF THE INVENTION

The following presents a simplified summary of the invention in order to provide a basic understanding of some aspects of the invention. This summary is not an extensive overview of the invention. It is not intended to identify key or critical elements of the invention or to delineate the scope of the invention; its sole purpose is to present concepts of the invention in a simplified form as a prelude to the more detailed description that is subsequently presented.

According to its major aspects and briefly stated, the present invention includes a grommet device and method for using the grommet in hanging window treatments and accessories. Traditionally, a grommet used in window treatments includes two pieces. The first piece generally has a ring-like or annular shape similar to, but not limited to, a washer. This piece can be flat, rounded, or shaped and includes a central opening. As used herein, the term “grommet washer” includes any shaped piece that is used in connection with a grommet body to impart support, reinforcement or aesthetic appeal to drapery substrate openings. Grommet washers include, but are not limited to, washers, rings, and plates. The second piece, the grommet body, typically includes a rounded or shaped flange portion surrounding a raised barrel or volcano-shaped portion with a central opening. Other shapes for the raised portion of the grommet body exist, including rectangular and oval. The raised portion is dimensioned to be received by the central opening of the grommet washer. Further, this raised portion will generally be crimped, flared, snapped or mushroomed to hold the finished assembly of the grommet pieces together.

In use, a traditional grommet assembly is applied to a drapery substrate in the following manner. An opening is made into a drapery needing to be hung. Next, the raised barrel portion of the grommet body is inserted through one side of the drapery opening, as well as the opening of a grommet washer positioned on the opposing side of the drapery opening. To secure the grommet, the raised portion is crimped in a radial direction outward from the central opening to maintain the grommet washer and the grommet body in place on the drapery substrate. Alternatively, the finished assembly can be screwed or snapped together if suitable snaps, barbs or screw threads are provided in the body and washer pieces of the grommet.

The present invention includes a grommet having one or more grommet pieces, such as a body and a washer. This invention is distinct from the traditional grommet devices in that one or more of the grommet pieces is eccentric and includes a means for attaching a variety of accessories, including batons, decorative trim, or stabilizing connectors. As used herein, the term “eccentric grommet” includes a piece of a grommet assembly that has a width, when measured radially, greater through a portion of its circumference. The greater or wider portion, which can generally be referred to as a flange, may be used in connection with draperies or other window treatments to facilitate opening and closing of the draperies and to add an ornamental design feature.

Many other variations to the invention also exist. The wider portion or flange with an attaching means can be contained on either or both the grommet body and the grommet washer so that the functional aspects of the invention can be included on either or both sides of a drapery substrate. For example, each grommet piece of a grommet assembly can include one or more wider portions. On each wider portion can be included one or more attaching means, such as openings formed therein, to facility the attachment of wands, cords, bead chains, or other flexible connectors.

More particularly, in one embodiment of the present invention, the grommet assembly includes a grommet body, a grommet washer, as well as an eccentric grommet washer having an attaching means. In an alternative embodiment, the grommet assembly includes only a grommet body in combination with an eccentric grommet washer. In another alternative embodiment, the grommet assembly includes an eccentric grommet body and a grommet washer. In yet another alternative embodiment, the grommet assembly includes an eccentric grommet body and an eccentric grommet washer. In each of these embodiments, each eccentric grommet piece can include one or more such wider portions, as well as one or more attaching means on each wider portion.

The grommet of the present invention can also include other variations in addition to the use of eccentric grommet pieces. For example, the grommet pieces can be embossed. Additionally, the grommet body of the present invention can either include raised portions or ridges to enhance the gripping of substrates, or, alternatively, the grommet body can be flat. Certain portions of the grommet body can be raised or ridged, while certain other portions of the grommet body can be flat. For example, the grommet body can include a raised neck portion surrounding a central opening and a flat flange portion extending out from body. Alternatively, the grommet body flange portion can be ridged.

A feature of the present invention includes the use of an eccentric grommet piece having a wider portion or flange including an attaching means. This feature offers alternative and convenient approaches to attaching and decorating window treatments. When used on the front side of draperies, any number of accessories can be connected to the attaching means of the wider portion of the eccentric grommet piece, including batons, decorative trim, and embellishments. Moreover, this feature provides a means by which multiple grommets are connected through the attaching means of the eccentric pieces. The connection of grommets, through bead chains for example, can stabilize pleating on the backside of a drapery. Traversing a grommeted drapery is facilitated through the use of the present invention, as traditional grommets tend to twist and bind on the hanging rod. Furthermore, decorative embellishments, such as tassels, can be hung from adjacent eccentric grommets.

Other features and their advantages will be readily apparent to those skilled in decorative arts, techniques and equipment from a careful reading of the Detailed Description of Embodiments, accompanied by the following drawings.

### BRIEF DESCRIPTION OF THE DRAWINGS

In the drawings,

FIG. 1 is a top view of a grommet washer according to an embodiment of the present invention;

FIG. 1A is a side view of a grommet washer according to an embodiment of the present invention;

FIG. 1B is a cross-sectional view of a grommet washer according to an embodiment of the present invention;

FIG. 2 is a top view of a grommet washer according to an embodiment of the present invention;

FIG. 3A is a top view of a grommet body;

FIG. 3B is a side elevation view of a grommet body;

FIG. 4A is a top view of a grommet body according to an embodiment of the present invention;

FIG. 4B is a side elevation view of a grommet body according to an embodiment of the present invention

FIG. 5 is a perspective view of grommet assembly including a baton according to an embodiment of the present invention;

FIG. 6 is a perspective view of a grommet assembly including a tassel according to an embodiment of the present invention;

FIG. 7 is a perspective view of a grommet assembly including multiple grommets linked by a chain according to an embodiment of the present invention;

FIG. 8 is an exploded, perspective view of a grommet assembly according to an embodiment of the present invention;

FIG. 9 is an exploded, perspective view of a grommet assembly according to an embodiment of the present invention;

FIG. 10 is an exploded, perspective view of a grommet assembly according to an embodiment of the present invention;

FIG. 11 is an exploded, perspective view of a grommet assembly according to an embodiment of the present invention.

### DETAILED DESCRIPTION OF PREFERRED EMBODIMENTS

The present invention includes a method, apparatus, and kit for use in hanging and decorating windows. In particular, the apparatus of the present invention includes an eccentric grommet piece 10 for use in grommet assemblies for window treatments such as draperies.

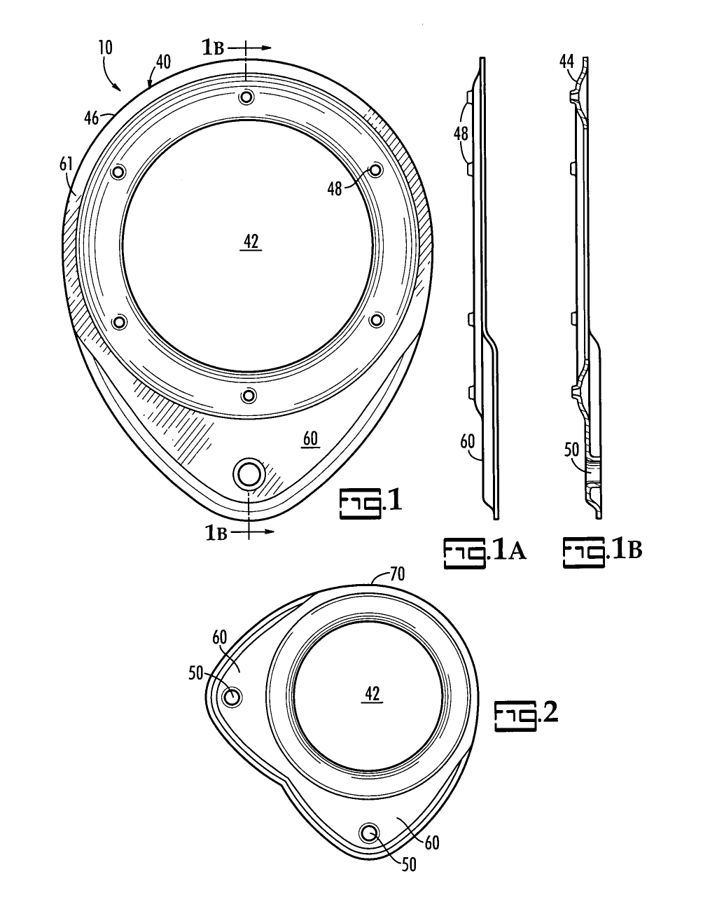

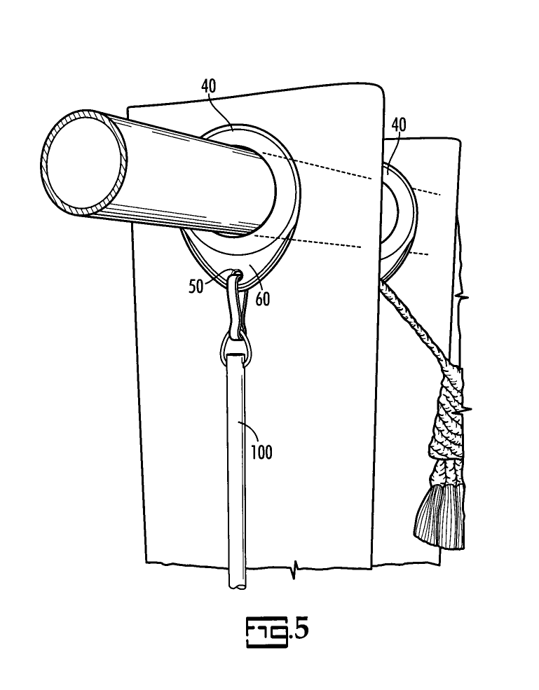

In one embodiment, shown in FIGS. 1-1B, the eccentric grommet piece 10 includes an eccentric grommet washer 40 dimensioned for use in with a grommet body 20, shown in FIGS. 3A-3B to form a grommet assembly. The features of the grommet body 20 are shown so as to place the eccentric grommet washer 40 of the present invention into context. It is thus within the purview of the present invention to combine the grommet washer 40 with other grommet bodies having a variety of features and dimensions.

As shown in FIG. 3, grommet body 20 has a circular hole 22 formed therein with a cylindrical barrel 24 integrally formed with body 20 along the periphery of the hole 22. Grommet body 20 may have additional features to provide stiffening, typically in the area surrounding hole 22, such as a concave rim 26.

Eccentric grommet washer 40 also has a circular hole 42 similar in size and preferably slightly larger than hole 22 in grommet body 20, through which barrel 24 is placed when grommet body 20 and eccentric grommet washer 40 are joined to form a grommet assembly. In use, grommet washer 40 and grommet body 20 are joined with a portion of fabric (not shown) therebetween, and barrel 24 is pressed radially outward from its cylindrical configuration to a disk-shape so that the grommet body 20 and the grommet washer 40 become secured to the fabric substrate. Grommet washer 40 may have features such as perforations 48 about its hole 42 to better grip the fabric, and may have other features to add stiffening to washer 40, such as a concave rim 44. Rim 26 of grommet body 20 and rim 44 of grommet washer 40, when brought together and properly oriented, will tend to nest.

Grommet washer 40 is further formed to include a wider portion 60 along its periphery. In particular, as measured from the center of hole 42, the distance to the edge 46 of washer 40 varies about that edge 46, increasing and then decreasing to define a wider part or portion 60 and a narrower part 61 so that washer 40 is eccentric in appearance, that is, not circular but elliptical.

The wider portion 60 or flange of grommet washer 40 includes an attaching means, such as one or more openings 50 formed therein. Wider portion 60 may itself carry ornamentation such as color, etching, attached ornamentation, designs in relief, and so forth. As grommet washer 40 may be made of metal, the appearance of the metal itself, shiny or brushed aluminum, brass, stainless steel, gold, silver, chrome, brushed nickel, iron, pewter, and so on, is attractive in its own right.

Depending on the application for the grommet, it may be important that the grommet washer 40 include only a single wider portion 60, such as the embodiment shown in FIGS. 1-1B. For example, if the grommet washer 40 is being used to carry an accessory or device that is independent from the remaining grommets along a fabric substrate. Alternatively, the use of a single wider portion 40 has aesthetic appeal, especially when the grommet washer 40 is positioned so that the wider portion is pointed downward away from the suspension rod of a fabric substrate.

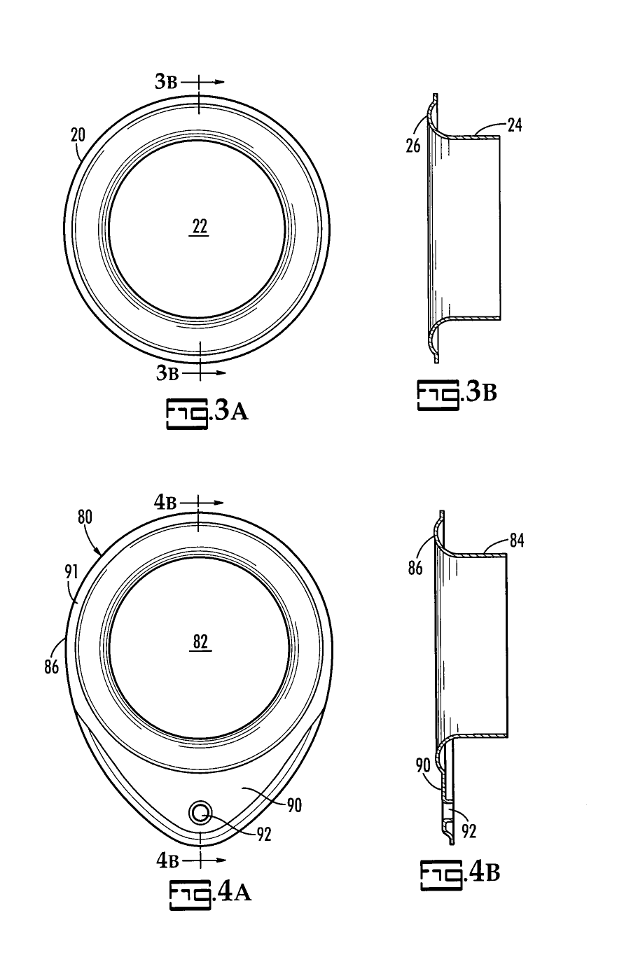

In an embodiment shown in FIG. 2, the eccentric grommet piece includes an eccentric grommet washer 70 that is formed to have more than one wider portion 60 that extends radially outward from the hole 42. Each of these wider portions 60 can further include one or more attaching means, such as one or more openings 50 formed therein. The use of a grommet washer 70 including only two separate wider portions 60, each including an attaching means, such as shown in FIG. 2, may be important, for example, to suspend an accessory such as a tassel from a single grommet. Hanging a tassel or other accessory may require both multiple attachment points, as well as attachment points that are spaced apart on a single grommet.

In an embodiment shown in FIGS. 4A-4B, the invention includes an eccentric grommet body 80 dimensioned for use in with a grommet washer to form a grommet assembly. The grommet washer used in connection with the eccentric grommet body 80 can either be a more conventional washer 140, shown generally in FIG. 8, or an eccentric grommet washer 40, such as previously described.

As illustrated, eccentric grommet body 80 has a circular hole 82 formed therein with a cylindrical barrel 84 integrally formed with body 80 along the periphery of the hole 82. Grommet body 80 may have additional features to provide stiffening, typically in the area surrounding hole 82, such as a concave rim 86. Further, grommet body 80 is formed to be wider along its periphery. In particular, as measured from the center of hole 82, the distance to the edge 86 of grommet body 80 varies about that edge 86, increasing and then decreasing to define a wider portion 90 and a narrower portion 91 so that body 80 is eccentric in appearance, that is, not circular but elliptical.

The wider portion 90 or flange of grommet body 80 includes an attaching means, such as one or more openings 92 formed therein. Wider portion 90 may itself carry ornamentation such as color, etching, attached ornamentation, designs in relief, and so forth. As grommet body 80 may be made of metal, the appearance of the metal itself, shiny or brushed aluminum, brass, stainless steel, gold, silver, chrome, brushed nickel, iron, pewter, and so on, is attractive in its own right. Although not shown, the eccentric grommet body 80 can also include more than one wider portion 90, with each wider portion including one or more attaching means.

Depending on the application for the grommet, it may be important that the grommet body 80 include only a single wider portion 90, such as the embodiment shown in FIGS. 4A-4B. For example, if the grommet body 80 is being used to carry an accessory or device that is independent from the remaining grommets along a fabric substrate. Alternatively, the use of a single wider portion 80 has aesthetic appeal, especially when the grommet washer 80 is positioned so that the wider portion is pointed downward away from the suspension rod of a fabric substrate.

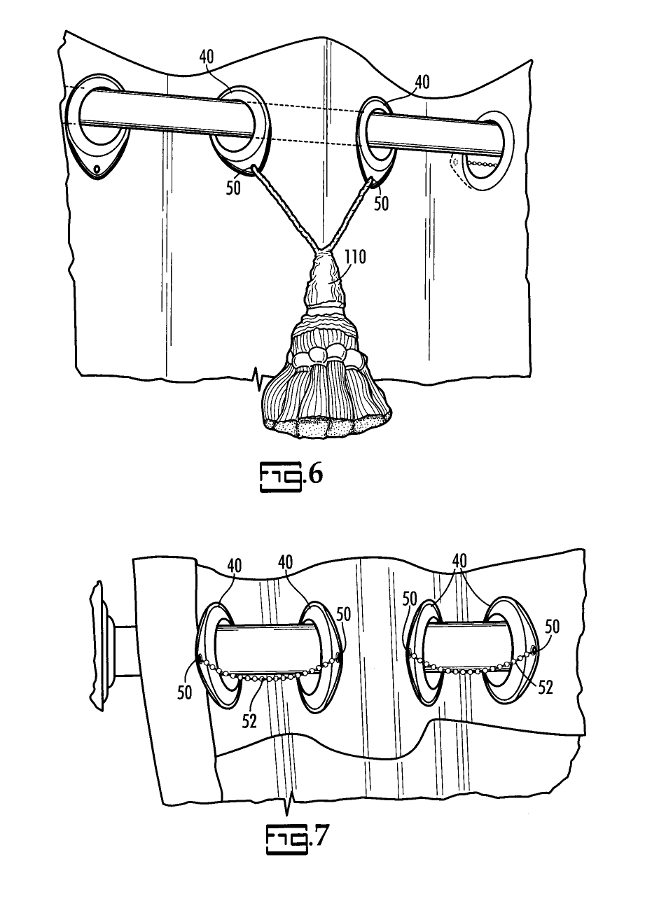

Based on the forgoing features, many variations to embodiments of the present invention are contemplated. For example, the grommet washer or, alternatively, the grommet body may be eccentric, or both. The eccentric grommet piece may include one or more wider portions. Both grommet body and washer may be congruent, that is, having the same eccentricity or different eccentricities and their wider parts may coincide or not coincide. The wider portion or portions of the eccentric piece may have one or more attaching means, and so forth. The eccentric grommet piece may be placed on the reverse side of the fabric or the front side, or both, depending on whether it is primarily functional (reverse side of fabric) or decorative (front side of fabric) or both. The ornamentation and purpose of the eccentric washer may be different than that of the eccentric body. One can support tassels on the front side of the drapery fabric and the other can support a functional bead chain to facilitate drawing the draperies on the back side of the drapery fabric. By way of example and not to limit the invention, some of these variations are generally shown FIGS. 5-7.

In an embodiment shown in FIG. 5, a grommet assembly of the present invention includes an eccentric grommet washer 40 having a wider portion 60 with an attaching means including an opening 50. This attaching means can be for use in connection with a drapery baton 100, as shown, or other ornamentation independent of that supported by adjacent grommets and attaching means.

As illustrated in FIG. 6, the grommet assembly can include adjacent grommet washers 40, each including an attaching means, such as openings 50. These openings 50 can work in cooperation to support tassels 110 or other ornamentation. Alternatively, the tassels 110 could also be suspended from a single grommet.

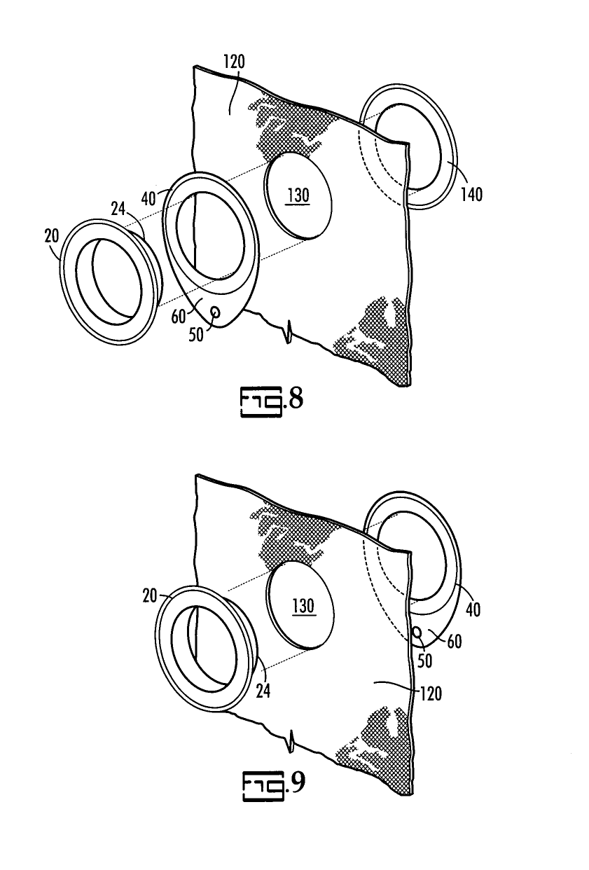

In FIG. 7, the grommet assembly includes adjacent, eccentric washers 40 having attaching means, such as openings 50. In particular, the attaching means can be used with a cord, bead chain or other flexible connector 52 that is threaded through opening 50 of one washer 40 to the opening 50 of the next washer 40 and so on. Connector 52 can thus be used to conjoin or connect drapery pleats draperies and may also be used for decoration as a scalloped feature on the front side of the fabric. Connector 52 may be decorative as well and made of a narrow fabric cable or rope.

Additional variations relating to the use of the present invention are shown in FIGS. 8-11. By way of example and not to limit the invention, these embodiments illustrate various methods for assembling the grommet of the present invention to a fabric substrate. In FIG. 8, a grommet body 20 and an eccentric grommet washer 40 is positioned on one side of a fabric substrate 120 including a substrate opening 130, and a conventional grommet washer 140 is positioned on the opposing side of the fabric substrate 120. These various pieces are mated or joined so that the central barrel portion 24 of the grommet body 20 is inserted through the openings of the substrate and the washers, and thereafter is crimped to secure the grommet assembly in place. Thereafter the fabric substrate is suspended such as by a hanging rod.

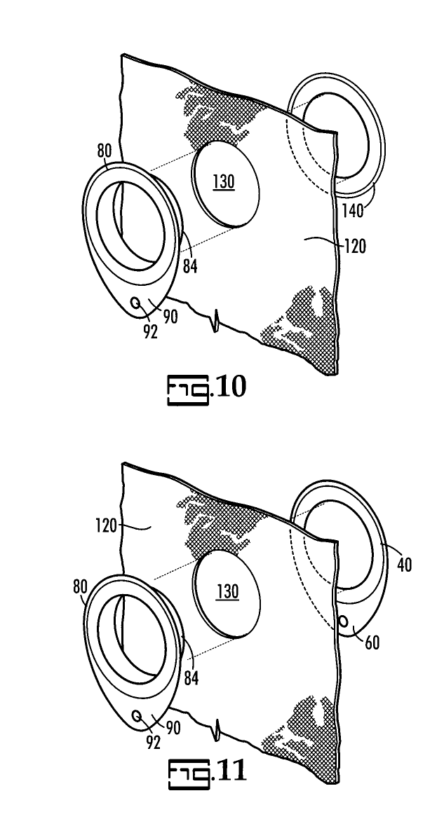

In FIG. 9, a grommet body 20 is positioned on one side of a fabric substrate 120 including a substrate opening 130, and an eccentric grommet washer 40 is positioned on the opposing side of the fabric substrate 120. These various pieces are mated or joined so that the central barrel portion 24 of the grommet body 20 is inserted through the openings of the substrate and the washer 40, and thereafter is crimped to secure the grommet assembly in place. Thereafter the fabric substrate is suspended such as by a hanging rod.

As illustrated in FIG. 10, an eccentric grommet body 80 is positioned on one side of a fabric substrate 120 including a substrate opening 130, and a conventional grommet washer 140 is positioned on the opposing side of the fabric substrate 120. These various pieces are mated or joined so that the central barrel portion 84 of the grommet body 80 is inserted through the openings of the substrate and the washer 140, and thereafter is crimped to secure the grommet assembly in place. Thereafter the fabric substrate is suspended such as by a hanging rod.

In FIG. 11, an eccentric grommet body 80 is positioned on one side of a fabric substrate 120 including a substrate opening 130, and an eccentric grommet washer 40 is positioned on the opposing side of the fabric substrate 120. These various pieces are mated or joined so that the central barrel portion 84 of the grommet body 80 is inserted through the openings of the substrate and the washer 40, and thereafter is crimped to secure the grommet assembly in place. Thereafter the fabric substrate is suspended such as by a hanging rod.

Those skilled in the art of grommet devices and the decorative arts will appreciate from the foregoing description of preferred embodiments that substitutions and modification can be made without departing from the spirit and scope of the invention which is defined by the appended claims.

What is claimed is:

1. A grommet for use with window treatments, said grommet comprising:
a washer having a hole and an outer edge, wherein the width of said washer varies as measured from the center of said hole to said outer edge so that said washer has a wider portion and a narrower portion, and wherein said wider portion of said washer includes means for attachment.

2. The grommet as recited in claim 1, wherein said attachment means is an opening.

3. The grommet as recited in claim 1, wherein said attachment means is a plurality of openings.

4. The grommet as recited in claim 1, wherein said wider portion is only a single wider portion.

5. The grommet as recited in claim 1, wherein said wider portion is only two wider portions.

6. The grommet as recited in claim 1, further comprising a body for use in connection with said washer, said body having an outer edge and hole with a cylindrical barrel formed along the periphery of said hole, and wherein the width of said body varies as measured from the center of said hole so that said body has a wider portion and a narrower portion, wherein said wider portion of said body includes means for attachment.

7. The grommet as recited in claim 6, wherein said attachment means of said body includes an opening.

8. The grommet as recited in claim 6, wherein said attachment means of said body includes a plurality of openings.

9. The grommet as recited in claim 6, wherein the width of said body varies so that said body includes only one said wider portion.

10. The grommet as recited in claim 6, wherein the width of said body varies so that said body includes only two said wider portions.

11. A grommet for use with window treatments, said grommet comprising:
body having an outer edge and hole with a cylindrical barrel formed along the periphery of said hole, and wherein the width of said body varies as measured from the center of said hole so that said body has a wider portion and a narrower portion, wherein said wider portion of said body includes means for attachment.

12. The grommet as recited in claim 11, wherein said attachment means of said body includes an opening.

13. The grommet as recited in claim 11, wherein the width of said body varies so that said body includes only one said wider portion.

14. The grommet as recited in claim 11, wherein the width of said body varies so that said body includes only two said wider portions.

15. The grommet as recited in claim 11, wherein said body has a concave rim surrounding said hole of said body, and wherein said grommet further comprises a washer having a hole and an outer edge, wherein the width of said washer varies as measured from the center of said hole to said outer edge so that said washer has a wider portion and a narrower portion, and wherein said washer has a concave rim surrounding said hole of said washer that is dimensioned to nest with said concave rime of said body.

16. A method for installing a window treatment, comprising:
providing an eccentric grommet including a hole and a wider portion, wherein said wider portion includes means for attachment;
providing a fabric substrate;
forming a hole in said fabric substrate;
joining said eccentric grommet with said fabric substrate at the respective holes;
securing said eccentric grommet to said fabric substrate;
suspending said fabric substrate with a hanging rod that is inserted through said grommet hole and said fabric hole.

17. The method as recited in claim 16, wherein said eccentric grommet is an eccentric washer.

18. The method as recited in claim 16, wherein said eccentric grommet is an eccentric body.

19. The method as recited in claim 16, wherein said eccentric grommet is an eccentric washer and an eccentric body.

20. A kit for installing a window treatment, comprising:
An eccentric grommet, having a hole and a wider portion, wherein said wider portion includes means for attachment.

21. The kit as recited in claim 20, wherein said eccentric grommet is an eccentric washer.

22. The method as recited in claim 20, wherein said eccentric grommet is an eccentric body.

23. The method as recited in claim 20, wherein said eccentric grommet is an eccentric washer and an eccentric body.
